(19) United States
(12) Patent Application Publication
(10) Pub. No.: US 2013/0260211 A1
(43) Pub. Date: Oct. 3, 2013

(54) NOVEL DEVICE FOR LAMINATING ELECTRODE ASSEMBLY AND SECONDARY BATTERY MANUFACTURED USING THE SAME

(71) Applicant: LG CHEM, LTD., Seoul (KR)

(72) Inventors: Ki Hong MIN, Gwacheon-si (KR); Sung Min HWANG, Cheongju-si (KR); Jihoon CHO, Daejeon (KR); TaeYoon JUNG, Cheongwon-gun (KR); Jeong Sam SON, Cheongju-si (KR); Changmin HAN, Cheongju-si (KR); Su Taek JUNG, Cheongju-si (KR); Hyun-sook BAIK, Cheongju-si (KR); Sung Hyun KIM, Cheongju-si (KR); Seok Jin KIM, Seoul (KR); Ki Hun SONG, Hwaseong-si (KR); Sang Hyuck PARK, Suwon-si (KR); Han Sung LEE, Incheon (KR); Byeong Geun KIM, Anyang-si (KR)

(73) Assignee: LG CHEM, LTD., Seoul (KR)

(21) Appl. No.: 13/899,995

(22) Filed: May 22, 2013

Related U.S. Application Data
(63) Continuation of application No. PCT/KR2011/008487, filed on Nov. 9, 2011.

(30) Foreign Application Priority Data
Dec. 2, 2010 (KR) 10-2010-0122326

(51) Int. Cl. B32B 37/00; H01M 2/16

(52) U.S. Cl. CPC B32B 37/0046; H01M 2/1673
USPC 429/156; 156/538; 429/209; 429/163

(57) ABSTRACT

Disclosed is a device for laminating an electrode assembly including a cathode, an anode and a separator interposed therebetween laminated in this order by thermal bonding, the device including an inlet, through which a web having the cathode/separator/anode laminate structure is fed, a heater to heat the web and thereby induce thermal bonding between the cathode, the separator and the anode, an outlet through which the thermally bonded web is discharged, and a transporter to transport the web through the inlet, the heater and the outlet, wherein the transporter imparts a transport driving force to the web in a state that the transporter contacts at least one of the top and the bottom of the web and the heater directly heats a region of the transporter contacting the web and thereby transfers thermal bonding energy to the web.

### TECHNICAL FIELD

The present invention relates to a novel device for laminating an electrode assembly and a secondary battery manufactured using the same. More specifically, the present invention relates to a device for laminating an electrode assembly comprising a cathode, an anode and a separator interposed therebetween laminated in this order by thermal bonding, the device comprising an inlet, through which a web having the cathode/separator/anode laminate structure is fed, a heater to heat the web and thereby induce thermal bonding between the cathode, the separator and the anode, an outlet through which the thermally bonded web is discharged, and a transporter to transport the web through the inlet, the heater and the outlet, wherein the transporter imparts a transport driving force to the web in a state that the transporter contacts at least one of the top and the bottom of the web and the heater directly heats a region of the transporter contacting the web and thereby transfers a thermal bonding energy to the web.

### BACKGROUND ART

Recently, rechargeable secondary batteries are widely used as energy sources or auxiliary power devices of wireless mobile devices. In addition, secondary batteries are drawing great attraction as power sources of electric vehicles (EVs), hybrid electric vehicles (HEVs), plug-in hybrid electric vehicles (PHEV) and the like suggested as alternatives to solve air contamination caused by conventional gasoline vehicles, diesel vehicles and the like using fossil fuels.

Such a secondary battery is manufactured in a state in which an electrode assembly is mounted in a battery case together with an electrolyte solution. Depending on manufacturing method, the electrode assembly is divided into a stack-type, a folding-type, a stack-folding type and the like. In the case of the stack type or stack-folding type electrode assembly, a unit assembly has a structure in which a cathode and an anode are laminated in this order such that a separator is interposed therebetween.

A lamination process to join electrodes to a separator is required in order to obtain such a unit assembly.

The lamination process generally includes adhering electrodes to the separator by heating the unit assembly. The heating for the lamination process is generally carried out by indirect heating using radiation and convection. Such indirect heating enables lamination during transport of the unit assembly since respective processes for manufacturing the secondary battery are intimately connected to one another.

However, the indirect heating by radiation and convection entails a long time for heating the unit assembly to a target temperature, as compared to direct heating in which heat is transported through direct contact.

Generally, in order to increase a process rate, the unit assembly moves over a long distance. For this reason, disadvantageously, the scale of the heating device should be increased and production costs are thus increased.

However, when direct heating for a short heating time is used in order to solve this problem, problems of decreased process rate and increased risk of occurrence of defects occur due to friction between the unit assembly and the heating portion.

Accordingly, there is a need for development of novel lamination devices.

### DISCLOSURE

### Technical Problem

Therefore, the present invention has been made to solve the above problems and other technical problems that have yet to be resolved.

It is one object of the present invention to provide a lamination device that enables lamination of a separator and an electrode within a relatively short time without lowering a process rate.

It is another object of the present invention to provide a secondary battery that exerts superior operation properties using the lamination device.

### Technical Solution

In accordance with one aspect of the present invention, provided is a device for laminating an electrode assembly including a cathode, an anode and a separator interposed therebetween laminated in this order by thermal bonding, the lamination device including: an inlet, through which a web having the cathode/separator/anode laminate structure is fed; a heater to heat the web and thereby induce thermal bonding between the cathode and the separator and the anode; an outlet through which the thermally bonded web is discharged; and a transporter to transport the web through the inlet, the heater and the outlet, wherein the transporter imparts a transport driving force to the web in a state that the transporter contacts at least one of the top and the bottom of the web and the heater directly heats a region of the transporter contacting the web and thereby transfers thermal bonding energy to the web.

According to the present invention, the heater directly heats a region of the transporter contacting the web, thereby transferring a thermal bonding energy to the web. As a result, heating and transportation of the web can be performed at the same time and problems caused by friction, such as deterioration in process rate or occurrence of defects can be thus overcome.

For example, the web is a material wherein an electrode assembly having a structure, in which a cathode and an anode are laminated in this order such that a separator is interposed therebetween, is arranged on a separator extended in a longitudinal direction. Here, the separator has a porous structure, like the separator, thus allowing permeation of ions such as lithium ions while electrically isolating the cathode from the anode in the manufactured secondary battery.

Such a web is moved at a predetermined rate. Accordingly, in order to heat the web for a predetermined time, according to the relation equation of rate-time-distance, heating throughout a specific length is required. Accordingly, any transporter may be used for the lamination device according to the present invention so long as it contacts the web at a predetermined length and simultaneously performs heating and transport.

In a preferred embodiment, the transporter may include a pair of rollers that rotate in one direction and a rotation belt that is rotated by the rollers while contacting the web.

In this structure, the rollers and rotation belts rotated by the rollers can control a heating time by controlling the length of the central axis of the rollers.

As defined above, the transporter imparts a transport driving force to the web in a state that the transporter contacts at least one of the top and the bottom of the web, preferably, may impart a transport driving force to the web in a state that the transporter contacts the top and the bottom of the web.

Imparting a transport driving force to the web in a state that the transporter contacts both the top and the bottom of the web is preferred, as compared to the state that the transporter contacts either the top or the bottom thereof, in terms of stable transport.

In this structure, the separator is preferably arranged on both the top and the bottom of the web. When the electrode is exposed outside in the web, the cathode material and the anode material may be separated during transport.

In some cases, in order to prevent adhesion between the lamination device and the separator, an additional protective film may be arranged between the web and the lamination device.

In this case, any protective film may be used without limitation so long as it is not changed at a lamination temperature and is not adhered to a separator. For example, the separator may be a polyolefin film, a polyethylene film, a polycarbonate film, a rubber film or the like.

In a specific embodiment, the transporter may include a pair of first rollers arranged on the top of the web and a first rotation belt that contacts the top of the web and is rotated by the first rollers; and a pair of second rollers arranged on the bottom of the web and a second rotation belt that contacts the bottom of the web and is rotated by the second rollers.

Preferably, the rotation belt of the transporter may be heated by the heater.

In this case, the heater directly heats the rotation belt, which is a region where the transporter directly contacts the web, thereby minimizing unnecessary loss of heat energy.

Accordingly, the heater is preferably arranged adjacent to the region of the rotation belt that contacts the web so that the heater heats the rotation belt region that contacts the web.

Any rotation belt may be used regardless of the type thereof so long as it can conduct heat and has flexibility to the extent that it can be rotated by the roller.

Preferably, the rotation belt may be made of a metal material. In addition, in terms of the manufacturing cost of device, conduction of heat energy, easy maintenance and the like, stainless steel is more preferred among metal materials.

In the lamination device according to the present invention, a heater temperature is preferably 80 to 105° C. When the heater temperature is lower than 80° C., time required for reaching the lamination temperature may be lengthened. On the other hand, when the heater temperature is higher than 105° C., the protective film may be adhered to the surface of the transporter due to glass crystallization, thus making processing impossible.

For this reason, the heater temperature is more preferably 90 to 103° C.

In the lamination device according to the present invention, the transport rate of the web is preferably 400 to 450 mm/s

The transport rate of the web may be suitably controlled depending on the process. However, preferably, the desired lamination is accomplished by allowing the web to pass through the lamination device at the transport rate defined above in order to prevent the lamination process from being a bottleneck of the overall process.

In this case, a temperature elevation rate of the web by the heater is preferably 20°C./sec or higher, more preferably 30°C./sec to 50°C./sec.

In order to perform lamination at the transport rate, there is a need for the separator or separator that reaches from room temperature to a target temperature of 64.5° C. within 1.5 seconds. That is, in order to elevate the temperature by 30 to 45° C. within 1.5 seconds, the elevation temperature rate is required.

In a preferred embodiment, the heater and the transporter are arranged in an air-tight chamber and the chamber temperature may be set to be 20 to 70° C. higher than an air temperature.

When the heater and the transporter are exposed to the outside, loss of heat energy may occur. Accordingly, in order to prevent such loss, the heater and the transporter are preferably arranged in the air-tight chamber and an internal temperature of the chamber is more preferably set to be 20 to 70° C. higher than air temperature so that loss of heat energy caused by the difference between the internal temperature of the chamber, and the temperature of the heater and the transporter can be minimized.

The present invention also provides an electrode assembly manufactured by the device.

The electrode assembly has a structure in which a cathode and an anode are laminated such that a separator is interposed therebetween.

For example, the cathode is produced by applying a slurry prepared by mixing a cathode mixture containing a cathode active material with a solvent such as NMP to a cathode current collector, followed by drying and rolling.

The cathode mixture may further optionally contain a component such as a conductive material, a binder or a filler in addition to the cathode active material.

The cathode active material is, as a substance that causes electrochemical reactions, a lithium transition metal oxide comprising two or more transition metals and examples thereof include, but are not limited to, layered compounds such as lithium cobalt oxide (LiCoO₂) or lithium nickel oxide (LiNiO₂) substituted with one or more transition metals; lithium manganese oxide substituted with one or more transition metals; lithium nickel oxide represented by the formula of LiNi_{1-y}M_{y}O₂ (in which M=Co, Mn, Al, Cu, Fe, Mg, B, Cr, Zn or Ga, the lithium nickel oxide including one or more elements among the elements, 0.01≦y≦0.7); lithium nickel cobalt manganese composite oxides represented by Li_{1+z}Ni_{b}Mn_{c}Co_{1-(b+c+d)}M_{d}O_{(2-c)}A_{c} such as Li_{1+z}Ni_{1/3}Co_{1/3}Mn_{1/3}O₂ or Li_{1+z}Ni_{0.4}Mn_{0.4}Co_{0.2}O₂ (in which −0.5≦z≦0.5, 0.1≦b≦0.8, 0.1≦c≦0.8, 0≦d≦0.2, 0≦e≦0.2, b+c+d<1, M=Al, Mg, Cr, Ti, Si or Y, A=F, P or Cl); and olivine lithium metal phosphate represented by the formula of Li₁₊ₓM_{1-y}M′_{y}PO_{4-z}X_{z}(in which M=transition metal, preferably Fe, Mn, Co or Ni, M′=Al, Mg or Ti , X═F, S or N, −0.5≦x≦+0.5, 0≦y≦0.5, and 0≦z≦0.1).

The conductive material is commonly added in an amount of 1 to 30% by weight, based on the total weight of the mixture comprising the cathode active material. Any conductive material may be used without particular limitation so long as it has suitable conductivity without causing adverse chemical changes in the battery. Examples of conductive materials include conductive materials, including graphite; carbon blacks such as carbon black, acetylene black, Ketjen black, channel black, furnace black, lamp black and thermal black; conductive fibers such as carbon fibers and metallic fibers; metallic powders such as carbon fluoride powders, aluminum powders and nickel powders; conductive whiskers such as zinc oxide and potassium titanate; conductive metal oxides such as titanium oxide; and polyphenylene derivatives.

The binder is a component which enhances binding of an electrode active material to a conductive material and current collector. The binder is commonly added in an amount of 1 to 30% by weight, based on the total weight of the mixture comprising the cathode active material. Examples of the binder include polyvinylidene, polyvinyl alcohol, carboxymethylcellulose (CMC), starch, hydroxypropylcellulose, regenerated cellulose, polyvinyl pyrrolidone, tetrafluoroethylene, polyethylene, polypropylene, ethylene propylene diene terpolymer (EPDM), sulfonated EPDM, styrene butadiene rubbers, fluororubbers and various copolymers.

The filler is a component optionally used to inhibit expansion of the electrode. Any filler may be used without particular limitation so long as it does not cause adverse chemical changes in the manufactured battery and is a fibrous material. Examples of the filler include olefin polymers such as polyethylene and polypropylene; and fibrous materials such as glass fibers and carbon fibers.

The cathode current collector is generally manufactured to have a thickness of 3 to 500 μm. Any cathode current collector may be used without particular limitation so long as it has suitable conductivity without causing adverse chemical changes in the manufactured battery. Examples of the cathode current collector include stainless steel, aluminum, nickel, titanium, sintered carbon, and aluminum or stainless steel surface-treated with carbon, nickel, titanium or silver. These current collectors include fine irregularities on the surface thereof so as to enhance adhesion to electrode active materials. In addition, the current collectors may be used in various forms including films, sheets, foils, nets, porous structures, foams and non-woven fabrics.

For example, the anode is produced by applying a slurry prepared by mixing an anode mixture containing an anode active material with a solvent such as NMP to an anode current collector, followed by drying. The anode mixture may further optionally contain components such as a conductive material, a binder or a filler as mentioned above.

Examples of the anode active material include carbon and graphite materials such as natural graphite, artificial graphite, expanded graphite, carbon fiber, hard carbon, carbon black, carbon nanotubes, perylene, activated carbon; metals alloyable with lithium, such as Al, Si, Sn, Ag, Bi, Mg, Zn, In, Ge, Pb, Pd, Pt and Ti and compounds containing these elements; composites of carbon and graphite materials with a metal and a compound thereof; and lithium-containing nitrides. Of these, a carbon-based active material, a silicon-based active material, a tin-based active material, or a silicon-carbon-based active material is more preferred. The material may be used alone or in combination of two or more thereof

The anode current collector is generally fabricated to have a thickness of 3 to 500 μm. Any anode current collector may be used without particular limitation so long as it has suitable conductivity without causing adverse chemical changes in the battery. Examples of the anode current collector include copper, stainless steel, aluminum, nickel, titanium, sintered carbon, and copper or stainless steel surface-treated with carbon, nickel, titanium or silver, and aluminum-cadmium alloys. Similar to the cathode current collectors, the anode current collectors include fine irregularities on the surface thereof so as to enhance adhesion to electrode active materials. In addition, the current collectors may be used in various forms including films, sheets, foils, nets, porous structures, foams and non-woven fabrics.

The separator is interposed between the cathode and the anode. As the separator, an insulating thin film having high ion permeability and mechanical strength is used. The separator typically has a pore diameter of 0.01 to 10 μm and a thickness of 5 to 300 μm. As the separator, sheets or non-woven fabrics made of an olefin polymer such as polypropylene and/or glass fibers or polyethylene, which have chemical resistance and hydrophobicity, are used. When a solid electrolyte such as a polymer is employed as the electrolyte, the solid electrolyte may also serve as both a separator and an electrolyte.

The present invention also provides a secondary battery having a structure in which the electrode assembly is sealed together with the lithium salt-containing non-aqueous electrolyte in a battery case.

The lithium salt-containing, non-aqueous electrolyte is composed of a non-aqueous electrolyte and a lithium salt and examples of preferred electrolytes include non-aqueous organic solvents, organic solid electrolytes, inorganic solid electrolytes and the like.

Examples of the non-aqueous solvent include non-protic organic solvents such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydroxy franc, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate and ethyl propionate.

Examples of the organic solid electrolyte include polyethylene derivatives, polyethylene oxide derivatives, polypropylene oxide derivatives, phosphoric acid ester polymers, poly agitation lysine, polyester sulfide, polyvinyl alcohols, polyvinylidene fluoride, and polymers containing ionic dissociation groups.

Examples of the inorganic solid electrolyte include nitrides, halides and sulfates of lithium such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH and Li₃PO₄—Li₂S—SiS₂.

The lithium salt is a material that is readily soluble in the above-mentioned non-aqueous electrolyte and examples thereof include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloroborane lithium, lower aliphatic carboxylic acid lithium, lithium tetraphenyl borate and imides.

Additionally, in order to improve charge/discharge characteristics and flame retardancy, for example, pyridine, triethylphosphite, triethanolamine, cyclic ether, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride or the like may be added to the non-aqueous electrolyte. If necessary, in order to impart incombustibility, the non-aqueous electrolyte may further contain halogen-containing solvents such as carbon tetrachloride and ethylene trifluoride. Further, in order to improve high-temperature storage characteristics, the non-aqueous electrolyte may further contain carbon dioxide gas or the like.

The battery case may be a cylindrical can, a rectangular can or a pouch to which a lamination sheet is thermally bonded. Of these, the pouch-shaped case may be generally used due to advantages such as low weight, low manufacturing cost and easy shape change.

The laminate sheet includes an inner resin layer in which thermal bonding is performed, a barrier metal layer, and an outer resin layer that exerts durability.

The outer resin layer should have superior resistance to exterior environments, thus requiring a predetermined level or more of tensile strength and weather resistance. In this regard, a polymer resin for the outer coating layer may contain polyethylene naphthalate (PEN), polyethylene terephthalate (PET) or oriented nylon that exhibit superior tensile strength and weather resistance.

In addition, the outer coating layer is made of polyethylene naphthalate (PEN) and/or is provided at the outer surface thereof with a polyethylene terephthalate (PET) layer.

Polyethylene naphthalate (PEN) exhibits superior tensile strength and weather resistance even at a small thickness as compared to polyethylene terephthalate (PET) and is thus suitable for use as an outer coating layer.

The polymer resin for the inner resin layer may be a polymer resin that has a thermal bonding property (thermal adhesion property), low hygroscopicity of the electrolyte solution to prevent permeation of the electrolyte solution thereinto and is not expanded or deposited by the electrolyte solution and is more preferably a chlorinated polypropylene (CPP) film.

In a preferred embodiment, the laminate sheet according to the present invention may include an outer coating layer having a thickness of 5 to 40 μm, a barrier layer having a thickness of 20 to 150 μm, and an inner sealant layer having a thickness of 10 to 50 μm. When the thicknesses of respective layers of the laminate sheet are excessively small, barrier performance of the materials and improvement in strength cannot be expected and, on the other hand, when the thicknesses are excessively large, disadvantageously, processability is deteriorated and thicknesses of sheets are increased.

Such a secondary battery may be used for a battery cell used as a power source of small devices as well as a unit battery for middle and large battery modules including a plurality of battery cells used as power sources of middle and large devices requiring high-temperature stability, long cycle characteristics and high rate characteristics and the like.

Examples of preferred middle and large devices include, but are not limited to, power tools powered by battery-driven motors; electric vehicles including electric vehicles (EVs), hybrid electric vehicles (HEVs) and plug-in hybrid electric vehicles (PHEVs); electric two-wheeled vehicles including electric bikes (E-bikes), electric scooters (E-scooter); electric golf carts, electric power storage system and the like.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a lamination device according to one embodiment of the present invention; and

FIG. 2 is a graph showing variation in temperature of a web according to contact heating.

### BEST MODE

Now, the present invention will be described in more detail with reference to the following examples. These examples are provided only to illustrate the present invention and should not be construed as limiting the scope and spirit of the present invention.

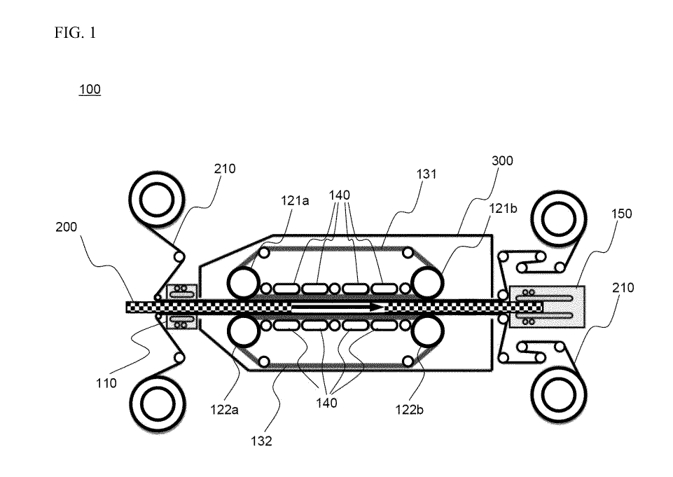

FIG. 1 is a schematic view illustrating a lamination device according to one embodiment of the present invention.

Referring to FIG. 1, the lamination device 100 includes an inlet 110 through which the web 200 is fed; first and second rotation belts 131 and 132 that contact the web 200 and perform transport; first and second rollers 121a, 121b, 122a and 122b that rotate the first and second rotation belts 131 and 132, respectively; a heater 140 that heats the first and second rotation belts 131 and 132 and thereby heats the web 200; and an outlet 150 through which the web 200 is discharged.

The web 200 is a component wherein a unit cell of an electrode assembly is arranged on a separator and the unit cell may be a full cell or a bi-cell (not shown).

As the unit cell, the full cell has a unit structure of cathode/separator/anode in which a cathode and an anode are arranged at both sides of the cell, respectively. Examples of such a full cell include a cathode/separator/anode cell (the most basic structure), cathode/separator/anode/separator/cathode/separator/anode and the like.

In addition, as the unit cell, the bi-cell is a cell in which identical electrodes are arranged at both sides of the cell, such as a cathode/separator/anode/separator/cathode unit structure or anode/separator/cathode/separator/anode unit structure. Generally, the cell having a cathode/separator/anode/separator/cathode structure is referred to as a “C-type bi-cell”, and a cell having an anode/separator/cathode/separator/anode structure is referred to as an “A-type bi-cell”. That is, a cell in which a cathode is arranged at both sides thereof is referred to as a “C-type bi-cell” and a cell in which an anode is arranged at both sides thereof is referred to as an “A-type bi-cell”.

The numbers of the cathode, anode and separator constituting these bi-cells are not particularly limited so long as the electrodes arranged at both sides of the cells are identical.

Before the web 200 is fed through the inlet 110, a protective film 210 is arranged on the top and bottom of the web 200. The protective film 210 prevents, for example, separation of the cathode and anode materials which may occur when the electrode arranged on the top of the web 200 directly contacts the rotation belts 131 and 132 and prevents adhesion of the separator arranged on the bottom of the web 200 to the rotation belts 131 and 132. Such a protective film 210 is collected, before the laminated web is discharged through the outlet 150.

The first rollers 121a and 121b rotate in a counterclockwise direction, thus allowing the first rotation belt 131 to rotate in the counterclockwise direction, and thereby applying a transport force from the left to the right of the web 200. In addition, conversely to the first rollers 121a and 121b, the second rollers 122a and 122b rotate in a clockwise direction, thus allowing the second rotation belt 132 to rotate in the clockwise direction and thereby applying a transport force from the left to the right of the web 200.

The lamination device 100 is air tight with the chamber 300 during lamination. By performing lamination in the air-tight chamber 300, unnecessary loss of heat can be reduced and more efficient lamination can be achieved.

In order to reduce heat loss, the chamber 300 is set to a temperature 20 to 70° C. higher than an air temperature.

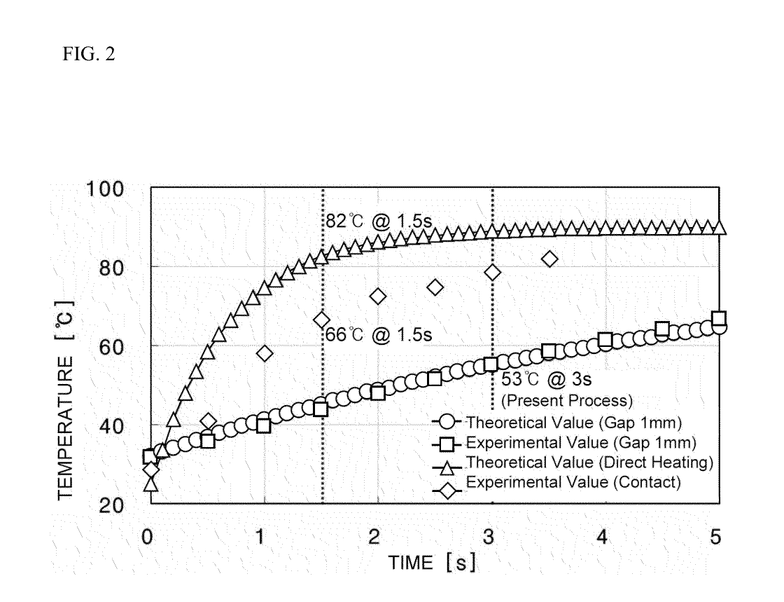

FIG. 2 is a graph showing variation in temperature of the web depending on contact heating.

Referring to FIG. 2, when the distance between the heater and the web is 1 mm, a theoretically analyzed value is equivalent to an experimental value and the temperature is elevated to 53° C. within 3 seconds. In a case of direct heating, the theoretically analyzed value for temperature elevation was 82° C. within 1.5 seconds. On the other hand, the experimental value obtained by actual direct heating was 66° C. within 1.5 seconds. From these results, it can be seen that direct (contact) heating enables elevation to a target temperature two or more time faster than conventional indirect heating, thus reducing lamination time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As apparent from the afore-going, the lamination device according to the present invention performs heating and transport simultaneously while directly contacting the web, thereby completing lamination within a short time and contributing to improvement in overall process efficiency.

1. A device for laminating an electrode assembly comprising a cathode, an anode and a separator interposed therebetween laminated in this order by thermal bonding, the device comprising:
an inlet, through which a web having the cathode/separator/anode laminate structure is fed,
a heater to heat the web and thereby induce thermal bonding between the cathode, the separator and the anode;
an outlet, through which the thermally bonded web is discharged; and
a transporter to transport the web through the inlet, the heater and the outlet,
wherein the transporter imparts a transport driving force to the web in a state that the transporter contacts at least one of the top and the bottom of the web, and the heater directly heats a region of the transporter contacting the web and thereby transfers slight thermal bonding energy to the web.

2. The device according to claim 1, wherein the transporter comprises a pair of rollers that rotate in one direction and a rotation belt that is rotated by the rollers while the rotation belt contacts the web.

3. The device according to claim 1, wherein the transporter imparts a transport driving force to the web in a state that the transporter contacts both the top and the bottom of the web.

4. The device according to claim 3, wherein the transporter comprises:
a pair of first rollers arranged on the top of the web and a first rotation belt that contacts the top of the web and is rotated by the first rollers; and
a pair of second rollers arranged on the bottom of the web and a second rotation belt that contacts the bottom of the web and is rotated by the second rollers.

5. The device according to claim 2, wherein the rotation belt of the transporter is heated by the heater.

6. The device according to claim 5, wherein the heater is arranged adjacent to a region of the rotation belt contacting the web so that the heater heats the region of the rotation belt contacting the web.

7. The device according to claim 2, wherein the rotation belt is made of a metal material.

8. The device according to claim 7, wherein the rotation belt is made of stainless steel.

9. The device according to claim 1, wherein a temperature of the heater is 80 to 105° C.

10. The device according to claim 1, wherein a transport rate of the web is 400 to 450 mm/s.

11. The device according to claim 1, wherein a temperature elevation rate of the web by the heater is 20° C./sec or more.

12. The device according to claim 11, wherein a temperature elevation rate of the web by the heater is 30° C./sec to 50° C./sec.

13. The device according to claim 1, wherein the heater and the transporter are arranged in an air-tight chamber and the chamber is set at a temperature 20 to 70° C. higher than an air temperature.

14. An electrode assembly manufactured using the device according to claim 1.

15. A secondary battery wherein the electrode assembly according to claim 14 is sealed together with an electrolyte solution in a battery case.

16. A battery pack comprising two or more of the secondary battery according to claim 15 as a unit battery.

17. The battery pack according to claim 16, wherein the battery pack is used as a power source of an electric vehicle (EV), a hybrid electric vehicle (HEV), a plug-in hybrid electric vehicle (PHEV) or an electric power storage system.
